(19) United States
(12) Patent Application Publication
(10) Pub. No.: US 2017/0223300 A1
(43) Pub. Date: Aug. 3, 2017

(54) IMAGE DISPLAY APPARATUS, METHOD FOR DRIVING THE SAME, AND COMPUTER - READABLE RECORDING MEDIUM

(71) Applicant: SAMSUNG ELECTRONICS CO., LTD., Suwon-si (KR)

(72) Inventor: Du-he JANG, Suwon-si (KR)

(21) Appl. No.: 15/389,813

(22) Filed: Dec. 23, 2016

(30) Foreign Application Priority Data
Feb. 1, 2016 (KR) 10-2016-0012188

(51) Int. Cl. H04N 5/44; G06T 19/00; H04N 19/17; H04N 19/44

(52) U.S. Cl. CPC H04N 5/44; H04N 19/44; G06T 19/006; H04N 19/17

(57) ABSTRACT

An image display apparatus, a method for driving the same, and a non-transitory computer-readable recording medium are provided. The image display apparatus includes an image receiver configured to receive a plurality of compressed images comprising an original image, a signal processor configured to decode a compressed image corresponding to a region of interest (e.g., a user's region of interest) from among the plurality of received compressed images, and a display configured to display the decoded compressed image.

### CROSS-REFERENCE TO RELATED APPLICATION

This application is based on and claims priority under 35 U.S.C. §119 to Korean Patent Application No. 10-2016-0012188, filed on Feb. 1, 2016, in the Korean Intellectual Property Office, the disclosure of which is incorporated by reference herein in its entirety.

### BACKGROUND

1. Field

The present disclosure relates generally to an image display apparatus, a method for driving the same, and a non-transitory computer-readable recording medium, and for example, to an image display apparatus for efficiently reproducing a 360-degree Virtual Reality (VR) image, for example, a method for driving the same, and a computer-readable recording medium.

2. Description of Related Art

A 360-degree VR image refers to a moving image that can be displayed rotating in forward, backward, upward, downward, right, and left directions through a VR apparatus or a video sharing site (You**be). The 360-degree VR image reconstructs and display a user's region of interest in a planar image expressed by equi-rectangular (or spherical square) projection. The 360-degree VR image is displayed to the user with a region less than one fourth (¼) of the entire image.

In the related art, image display apparatuses decode the entire image including the region that is not provided to the user, which consumes power of a decoder. By way of example, when a VR original image has resolution of Ultra High Definition (UHD), a region provided to the user may have the resolution lower than full HD. However, a decoder provides a service only when UHD decoding is available. Accordingly, as the resolution of a VR original image becomes higher in the future, the service may become unavailable unless capability of the decoder is improved (for example, 4K→8K→16K→32K).

### SUMMARY

The present disclosure addresses the aforementioned and other problems and disadvantages occurring in the related art, and an example aspect of the present disclosure provides an image display apparatus for efficiently reproducing a 360-degree VR image, for example, a method for driving the same, and a computer-readable recording medium.

According to an example embodiment of the present disclosure, an image display apparatus is provided. The apparatus includes an image receiver configured to receive a plurality of compressed images comprising an original image, a signal processor configured to decode a compressed image corresponding to a region of interest from among the plurality of received compressed images, and a display configured to display the decoded compressed image.

The image receiver may receive coordinate information on a region divided on a hourly basis in the plurality of compressed images along with the plurality of compressed images. Further, the signal processor may decode the compressed image corresponding to the region of interest based on the received coordinate information.

The image receiver may receive the plurality of compressed images with a different size of region divided on a hourly basis.

The image receiver may receive a planar image expressed by equi-rectangular projection to display a Virtual Reality (VR) image in a screen as the original image.

The apparatus may further include a storage configured to store the plurality of received compressed images in Group of Pictures (GOP) units. Further, the signal processor may decode the compressed image corresponding the region of interest in the compressed images stored in the GOP units.

The signal processor may decode the compressed image from at least one of a previous frame and a subsequent frame of a current frame corresponding to the region of interest.

In response to the plurality of received compressed images being low-resolution images, the signal processor may decode the compressed image to an ending point of the GOP units of the compressed image corresponding to the region of interest.

The low-resolution images may include a thumbnail image.

According to an example embodiment of the present disclosure, a method for driving an image display apparatus is provided. The method includes receiving a plurality of compressed images comprising an original image, decoding a compressed image corresponding to a region of interest from among the plurality of received compressed images, and displaying the decoded compressed image.

The receiving may include receiving coordinate information on a region divided on a hourly basis in the plurality of compressed images along with the plurality of compressed images. Further, the decoding may include decoding the compressed image corresponding to the region of interest based on the received coordinate information.

The receiving may include the plurality of compressed images with a different size of region divided on a hourly basis.

The receiving may include receiving a planar image expressed by equi-rectangular projection to display a Virtual Reality (VR) image in a screen as the original image.

The method may further include storing the plurality of received compressed images in Group of Pictures (GOP) units. Further, the decoding may include decoding the compressed image corresponding to the region of interest in the compressed images stored in the GOP units.

The decoding may include decoding the compressed image from at least one of a previous frame and a subsequent frame of a current frame corresponding to the region of interest.

In response to the plurality of received compressed images being low-resolution images, the decoding may include decoding the compressed image to an ending point of the GOP units of the compressed image corresponding to the region of interest.

The low-resolution images may include a thumbnail image.

According to an example embodiment of the present disclosure, a non-transitory computer-readable recording medium with a program for executing a method for driving an image display apparatus is provided. The method includes receiving a plurality of compressed images comprising an original image and decoding a compressed image corresponding to a region of interest from among the plurality of received compressed images.

### BRIEF DESCRIPTION OF THE DRAWINGS

The above and/or other aspects, features and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example service system according to an example embodiment disclosed herein;

FIG. 2 is a block diagram illustrating an example structure of an image relay apparatus of FIG. 1;

FIG. 3 is a block diagram illustrating an example of a structure of a second image display apparatus of FIG. 1;

FIG. 4 is a block diagram illustrating an example of a structure of a division-decoding signal processor of FIG. 3;

FIG. 5 is a diagram illustrating an example of a structure of a controller of FIG. 4;

FIG. 6 is a diagram illustrating an example of a structure of the division-decoding signal processor of FIG. 3 or a division-decoding executor of FIG. 4;

FIG. 7 is a diagram illustrating an example VR planar image for describing selective decoding according to an example embodiment disclosed herein;

FIG. 8 is a block diagram illustrating an example of a structure of a first image display apparatus according to another example embodiment disclosed herein;

FIG. 9 is a block diagram illustrating an example of a structure of a service provider of FIG. 1;

FIG. 10 is a diagram illustrating an example division-encoding signal processor of FIG. 9;

FIGS. 11 and 12 are diagrams illustrating an example of an unequally divided region for selective division-decoding according to an example embodiment disclosed herein;

FIG. 13 is a sequence diagram illustrating an example service process according to an example embodiment disclosed herein;

FIG. 14 is a flowchart illustrating an example selective decoding process according to an example embodiment disclosed herein; and

FIG. 15 is a flowchart illustrating an example process of generating an unequally divided compressed image according to an example embodiment disclosed herein.

### DETAILED DESCRIPTION

The various example embodiments of the present disclosure may be diversely modified. Accordingly, various example embodiments are illustrated in the drawings and are described in greater detail in the detailed description. However, it is to be understood that the present disclosure is not limited to a specific example embodiments, but includes all modifications, equivalents, and substitutions without departing from the scope and spirit of the present disclosure. Also, well-known functions or constructions may not be described in detail if they would obscure the disclosure with unnecessary detail.

The terms “first”, “second”, etc. may be used to describe diverse components, but the components are not limited by the terms. The terms are only used to distinguish one component from the others.

The terms used in the present application are only used to describe the various example embodiments, but are not intended to limit the scope of the disclosure. The singular expression also includes the plural meaning as long as it does not conflict with the context. In the present application, the terms “include” and “consist of” designate the presence of features, numbers, steps, operations, components, elements, or a combination thereof that are written in the disclosure, but do not exclude the presence or possibility of addition of one or more other features, numbers, steps, operations, components, elements, or a combination thereof.

Hereinafter, the present disclosure will be described in greater detail with reference to the accompanying drawings.

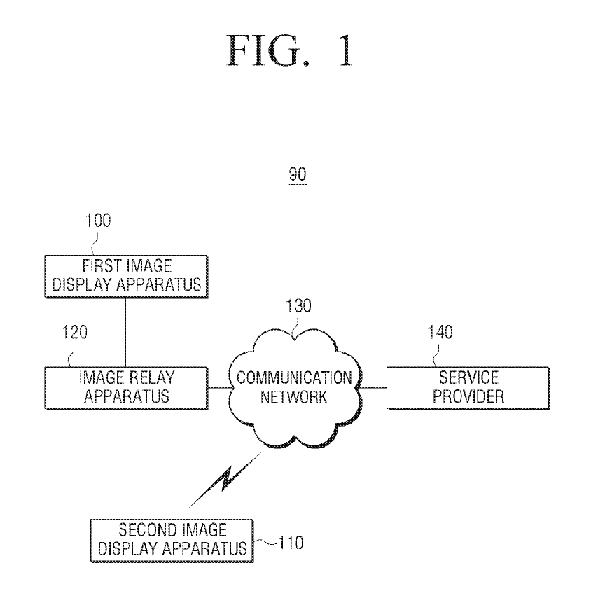

FIG. 1 is a diagram illustrating an example service system according to an example embodiment of the present disclosure.

Referring to FIG. 1, a service system 90 according to an example embodiment disclosed herein includes some or all of first and second image display apparatuses 100, 110, an image relay apparatus 120, a communication network 130, and a service provider 140.

The first and second image display apparatuses 100, 110 may include various kinds of apparatuses, such as, computers including a laptop computer, a desktop computer, or a tablet Personal Computer (PC), mobile phones including a smart phone, a Plasma Display Panel (PDP), wearable devices, televisions (TV), VR devices combinable with a mobile phone, or the like, but are not limited thereto. The first and second image display apparatuses 100, 110 may decode and display an image provided by the service provider 140, for example, a 360-degree VR image according to an embodiment disclosed herein in a screen directly. Further, the first image display apparatus 100 may operate with the image relay apparatus 120 and display an image decoded and provided by the image relay apparatus 120 in the screen. In response to an image being relayed through the image relay apparatus 120, the first image display apparatus 100 may decode the image.

In the following description of FIG. 1, it is assumed that the second image display apparatus 110 and the image relay apparatus 120 decode a VR image, and wired communication and wireless communication are performed by the first image display apparatus 100 and the second image display apparatus 110, respectively, for convenience in explanation.

The second image display apparatus 110 includes a display device that is capable of performing the wireless communication. By way of example, a wireless terminal, such as, a mobile phone, may communicate with a base station of a particular communication carrier included in the communication network 130 (for example, e-Node) or an access point in a user's home (for example, wireless router) to receive a VR image provided by the service provider 140.

The image relay apparatus 120 may include, for example, a set-top box (STB), a Video Cassette Recorder (VCR), a Blu-Ray player, or the like, but is not limited thereto, and operates in connection with the communication network 130. The image relay apparatus 120 may operate in connection with a hub device, such as, a router, included in the communication network 130. This operation will be described below in greater detail.

For convenience in explanation, it is assumed that ‘selective decoding’ according to an embodiment disclosed herein is performed in the image relay apparatus 120. Accordingly, operations according to an embodiment disclosed herein are not particularly limited to the image relay apparatus 120.

The image relay apparatus 120 receives a 360-degree VR image from the service provider 140 according to a request of the first image display apparatus 100. The VR image may be a still image, for example, a thumbnail image with low resolution, or may be a moving image. As an example, image data of the moving image may be encoded and decoded such that the moving image is transmitted according to a standard of the service provider 140. In this case, the ‘standard’ refers to regulations related to a form of a data format or an encoding method of the image data.

Accordingly, the image relay apparatus 120 according to an embodiment disclosed herein may classify (or divide) a region based on a user's region of interest and provide coordinate information on the divided region based on the encoded image. On the other hand, the image relay apparatus 120 may encode an image by including the coordinate information on the user's region of interest. Assuming that an original image photographed by a camera, that is, a unit-frame image is provided. The original image may be a planar image expressed by the equi-rectangular projection. According to an embodiment disclosed herein, the unit-frame image may be encoded in macro block units. In this case, the macro block units may have the same size in the unit-frame image. Accordingly, the ‘region based on the user's region of interest’ according to an embodiment disclosed herein includes a plurality of macro blocks. Further, in view of the image relay apparatus 120, a plurality of regions according to an embodiment disclosed herein may refer to a compressed image of a region divided on a hourly basis in a plurality of compressed images. It is preferred that the region refers to capacity of data.

In this embodiment, it may be seen that division of a region is performed based on the user's region of interest with respect to the encoded unit-frame image. In this case, it is preferred that images on an upper part and a lower part of the unit-frame image are divided into larger regions, and an image on a center part is divided into smaller regions as compared with the images on the upper and lower parts, by considering the possibility of a large amount of loss or distortion of image information, that is, a pixel value of the images on the upper and lower parts, which may occur during a process of converting a spherical VR image to a planar image. Accordingly, decoding based on a region of interest, e.g., the user's region of interest, according to an embodiment disclosed herein includes decoding a plurality of macro blocks, for example. However, when image communication standards are reestablished in the future, it is possible to directly decode an image by the method of this embodiment without decoding the macro blocks. Accordingly, the operations are not limited to the above example.

The image relay apparatus 120 receives the encoded image divided based on the user's region of interest. In this case, the image relay apparatus 120 may receive coordinate information indicating the user's region of interest along with the divided encoded image. Accordingly, in response to receiving the encoded image where the region is divided, the image relay apparatus 120 may store the image in a memory temporarily upon receipt without decoding the image. In response to receiving the coordinate information on the user's region of interest from the first image display apparatus 100, the image relay apparatus 120 may select and encode only an encoded image of a corresponding part based on the coordinate information and transmit the encoded image to the first image display apparatus 100. In case of a mobile phone, for example, the user's region of interest may be determined by detecting a motion of the mobile phone through a sensor embedded in the mobile phone, such as, a geomagnetic sensor, a direction sensor, or the like.

The selective decoding process according to an embodiment disclosed herein may be modified in various ways. By way of example, the user's region of interest may be changed to another region gradually or changed by rapid scene change. In order to address this problem, in the embodiment disclosed herein, it is possible to store an image temporarily in Group of Pictures (GOP) units and select and decode only an image corresponding to the user's region of interest. In this case, in response to the user's region of interest beginning at Picture-B or Picture-P, not Picture-I, based on the GOP units, regardless of a screen type with an order of pictures I and P or a screen type with an order of pictures I, B, and P, the image relay apparatus 120 may determine that the user's region of interests begins at Picture-I in the corresponding GOP unit and perform the selective decoding. In this regard, according to this embodiment, the decoding may include decoding the image from at least one of a previous frame and a subsequent frame of a current frame where the user's region of interest begins. The GOP unit may be a set of a plurality of pieces of Picture-I, for example, a thumbnail image, a set of Picture-I and Picture-P, or a set of Picture-I, Picture-B, and Picture-P. The ‘screen type’ refer to a GOP unit constituting a picture, and the screen type determines an encoding order. Further, the GOP unit refers to a set of unit-frame images per second.

As described above, the image relay apparatus 120 may perform the decoding operation by properly using the above-described methods in order to increase decoding efficiency. The decoding method may be changed by a system designer, and thus, in this embodiment, the decoding method is not limited to the above example. The decoded VR image is transmitted to the first image display apparatus 100 and displayed in the screen.

The communication network 130 may include both a wired communication network and a wireless communication network. In this case, the wired communication network includes an internet network, such as, a cable network, a Public Switched Telephone Network (PSTN), or the like, and the wireless communication network includes Code Division Multiple Access (CDMA), Wideband CDMA (WCDMA), General System/Standard for Mobile Communication (GSM), Evolved Packet Core (EPC), Long Term Evolution (LTE), Wireless Broadband Internet (WiBro) network, or the like. However, the communication network 130 according to an embodiment disclosed herein is not limited thereto. The communication network 130 may be used for a cloud computing network under a cloud computing environment, for example, as an access network of a next-generation mobile communication system to be implemented in the future. By way of example, in response to the communication network 130 being the wired communication network, the access point in the communication network 130 may access an exchange office of a telephone company. In response to the communication network 130 being the wireless communication network, the access point in the communication network 130 may access a Serving GPRS Support Node (SGSN) or Gateway GPRS Support Node (GGSN) or access diverse relay apparatuses, such as, Base Station Transmission (BTS), NodeB, e-NodeB, or the like, to process the data.

The communication network 130 may include an access point. The access point includes a small base station usually installed inside buildings, such as, femto or pico. In this case, the femto base station and the pico base station are classified by the number of maximum connection of the second image display apparatus 110 or the image relay apparatus 120 according to the classification of the small base station. The access point includes a local area communication module for performing local area communication, such as, Zigbee, Wireless-Fidelity (Wi-Fi), or the like, with respect to the second image display apparatus 110. The access point may use a Transmission Control Protocol (TCP)/Internet Protocol (IP) or a Real-Time Streaming Protocol (RTSP) for the wireless communication. In this case, the local area communication may be performed in diverse standards, such as, a Radio Frequency (RF) including Wi-Fi, Bluetooth, Zigbee, IrDA, Ultra High Frequency (UHF), and Very High Frequency (VHF), Ultra Wide Band (UWB), or the like. Accordingly, the access point may extract a location of a data packet, designate an optimal communication path for the extracted location, and transmit the data packet to a next apparatus, for example, the second image display apparatus 110, along the designated communication path. The access point may share several circuits under a common network environment, for example, a router, a repeater, a relay device, or the like.

The service provider 140 according to an embodiment disclosed herein may provide a VR image requested by the first image display apparatus 100 or the second image display apparatus 110 and receive and store the VR image provided from a content provider for this operation. As described above, in response to receiving the VR image, the service provider 140 divides an original planar image into a plurality of regions such that the selective decoding based on the user's region of interest is performed in at least one of the second image display apparatus 110 and the image relay apparatus 120. According to an embodiment disclosed herein, the center parts of the original planar image may be divided into regions in a certain size, that is, the same size, and the upper and lower parts may be divided into regions of different sizes from the center parts. The coordinate information indicating the divided regions is transmitted when the decoded original planar image is transmitted. By way of example, the coordinate information may be an absolute coordinate value indicating a location of a pixel or may be a relative coordinate value calculated with reference to a center part of the planar image. Accordingly, the operation in this embodiment is performed based on a predetermined standard between the service provider 140 and the second image display apparatus 110 or the image relay apparatus 120.

In the above description regarding the service provider 140, the example of dividing the user's region of interest based on an encoded image was provided for better understanding of the present disclosure. However, in the future, an image may be encoded and transmitted based on only the user's region of interest. That is, regarding the expression ‘based on the encoded image,’ additional information according to encoding and encoded image data should be naturally different depending on whether the encoding is inter-encoding or intra-encoding. Accordingly, it is possible to perform the encoding based on the user's region of interest according to an embodiment disclosed herein, not the encoding in macro block units according to the intra-encoding, for example, with omitting the above elements. As described above, the service provider 140 according to an embodiment disclosed herein may encode the VR image in various methods and transmit the encoded VR image to the communication network 130.

Accordingly, it is possible to reduce a load, such as, for example, and without limitation, a processing load, a power load, or the like, according to the decoding, that is, power consumption according to the frequent decoding in the second image display apparatus 110 and the image relay apparatus 120, which leads to an increment in a data processing speed. More particularly, it is possible to encode a 360-degree VR image by dividing regions and selectively decode the user's region of interest thereby obtaining greater gains in terms of a memory and the power consumption according to the decoding.

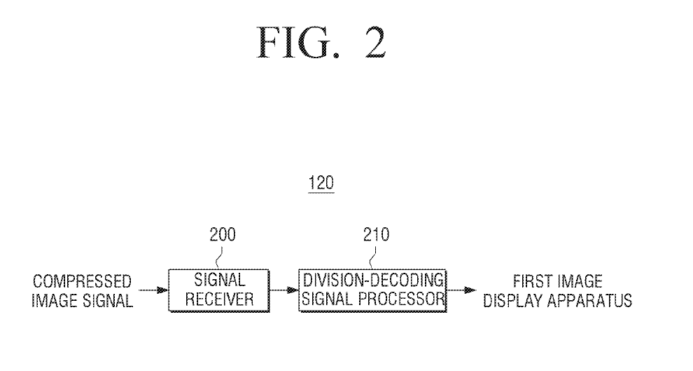

FIG. 2 is a block diagram illustrating an example structure of the image relay apparatus of FIG. 1.

As illustrated in FIG. 2, the image relay apparatus 120 according to an embodiment disclosed herein includes some or all of a signal receiver 200 and a division-decoding signal processor 210 (or signal processor).

Herein, ‘including some or all of components’ may denote that a certain component, for example, the signal receiver 200, may be omitted from the image relay apparatus 120 or may be integrated with another component, for example, the division-decoding signal processor 210. In the following description, it is assumed that the image relay apparatus 120 includes all of the above-described components, for better understanding of the present disclosure.

The image receiver 200 may include an image input terminal or an antenna for receiving an image and may further include a tuner or a demodulator. The tuner or the demodulator may belong to a category of the division-decoding signal processor 210. In this case, the image receiver 200 may request for a VR image to the communication network 130 according to the control of the division-decoding signal processor 210 and receive an image signal according to the request.

The division-decoding signal processor 210 stores the received image signal (for example, video data, audio data, or additional information) and performs the decoding selectively based on the user's region of interest. That is, the received image signal includes the coordinate information on the regions divided according to an embodiment disclosed herein on top of encoding information, such as, a motion vector. In this regard, the division-decoding signal processor 210 may determine which region in the first image display apparatus 100 the user has interests in, based on the coordinate information, and select and decode an image of a part corresponding to the coordinate information as the user's region of interest. In this case, in response to the user's region of interest initially beginning at Picture-B or Picture-P regardless of whether a screen type of the compressed images stored in the GOP units includes Picture-I and Picture-B or includes Picture-I, Picture-B, and Picture-P, the division-decoding signal processor 210 may move the user's region on interest to Picture-I of a previous phase belonging to the same GOP group and start decoding with Picture-I such that pictures from Picture-I to a section of transition time are decoded. This operation was described above, and thus, a repeated description is omitted.

Subsequently, the division-decoding signal processor 210 may transmit the selectively decoded VR image to the first image display apparatus 100. In this case, a size of an image in the user's region of interest displayed in the first image display apparatus 100 may differ from a size of the decoded image. In other words, in response to any part of the user's region of interest being included in the divided region, the corresponding region is decoded entirely, and thus, the size of the image of the user's region of interest displayed in the first image display apparatus 100 may be different from an actual size of the user's region of interest.

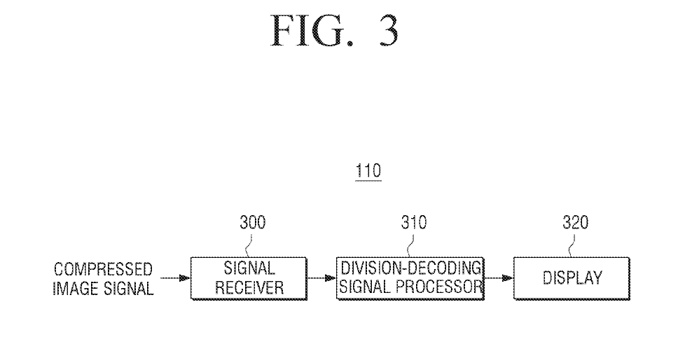

FIG. 3 is a block diagram illustrating an example of a structure of the second image display apparatus of FIG. 1.

As illustrated in FIG. 3, the second image display apparatus 110 may be embedded in a VR apparatus as a wireless terminal device, such as, a smart phone. The second image display apparatus 110 includes some or all of a signal receiver 300, a division-decoding signal processor 310, and a display 320.

Herein, ‘including some or all of components’ may denote that the division-decoding signal processor 310 may be integrated with the display 320, for example. By way of example, the division-decoding signal processor 310 may be realized on an image panel of the display 320 in a form of a Chip-on-Glass (COG). In the following description, it is assumed that the second image display apparatus 110 includes all of the above-described components, for better understanding of the present disclosure.

The signal receiver 300 and the division-decoding signal processor 310 of FIG. 3 perform the same operations as the signal receiver 200 and the division-decoding signal processor 210 of FIG. 2, and thus, a repeated description is omitted.

The display 320 may include diverse panels including Liquid Crystal Display (LCD), Organic Light-Emitting Diode (OLED), Plasma Display Panel (PDP), or the like, but is not limited thereto. Further, the division-decoding signal processor 310 may divide a received image signal into a video signal, an audio signal, and additional information (for example, encoding information or coordinate information), decode the divided video signal or audio signal, and perform a post-processing operation with respect to the decoded signal. The post-processing may include an operation of scaling a video signal. In the post-processing operation with respect to the decoded video data, it is possible to select only the user's region of interest and post-process only the selected region of interest, for example, scale the selected region. The display 320 displays the video data of the user's region of interest decoded by the division-decoding signal processor 310 in the screen. For doing this, the display 320 may further include various components, such as, a timing controller, a scan driver, a data driver, or the like. This operation may be apparent to a person having ordinary skill in the art (hereinafter referred to as ‘those skilled in the art’), and thus, a repeated description is omitted.

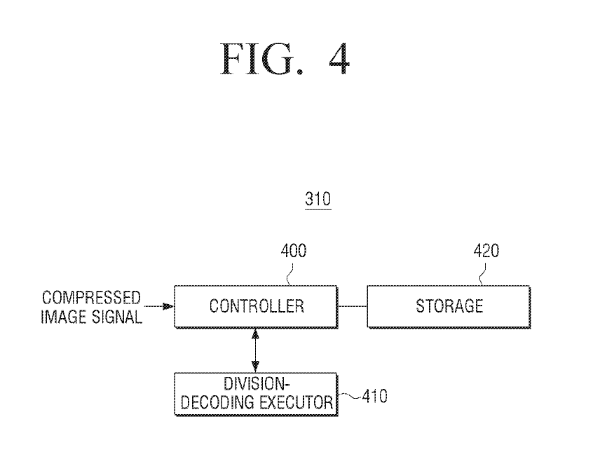

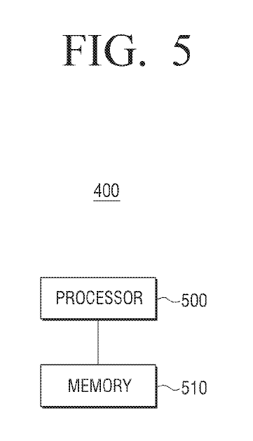

FIG. 4 is a block diagram illustrating an example of a detailed structure of the division-decoding signal processor of FIG. 3, and FIG. 5 is a diagram illustrating an example of a structure of a controller of FIG. 4.

As illustrated in FIG. 4, the division-decoding signal processor 310 includes some or all of a controller 400, a division-decoding executor 410, and a storage 420.

FIG. 3 is provided to describe an example that the division-decoding signal processor 310 performs both a control function and a decoding function as one program unit, and FIG. 4 is provided to describe an example that the division-decoding signal processor 310 performs the control function and the decoding function separately. That is, it may be seen that the controller 400 performs the control function, and the division-decoding executor 410 performs the decoding operation according to the control of the controller 400.

More particularly, the controller 400 controls overall operations of the division-decoding signal processor 310. As an example, in response to receiving an image signal, the controller 400 may store the image signal in the storage 420 in the GOP units.

The controller 400 selects (or extract) an image of the user's region of interest from the image signal stored in the GOP units based on the coordinate information on the user's region of interest. In this case, Picture-I may be a used as a reference for the decoding operation as described above. Subsequently, the controller 400 decodes a VR image in the selected user's region of interest through the division-decoding executor 410 and store the decoded VR image in the storage 420 temporarily or transmit the decoded VR image to the display 320 of FIG. 3.

The controller 400 may have a hardware-wise structure illustrated in FIG. 5. Accordingly, a processor 500 of the controller 400 may load a program stored in the division-decoding executor 410 to a memory 510 in response to an initial operation of the first image display apparatus 100, that is, in response to the first image display apparatus 100 being powered on, and execute the loaded program for the selective decoding operation thereby improving the data processing speed.

The division-decoding executor 410 may store a program for division-decoding as a form of a Read-Only Memory (ROM), for example, an Electrically Erasable and Programmable ROM (EEPROM) and execute the program according to the control of the controller 400. The stored program may be replaced periodically or updated as a form of firmware according to the control of the controller 400. This operation was described above in connection with the division-decoding signal processor 210 of FIG. 2, and thus, a repeated description is omitted.

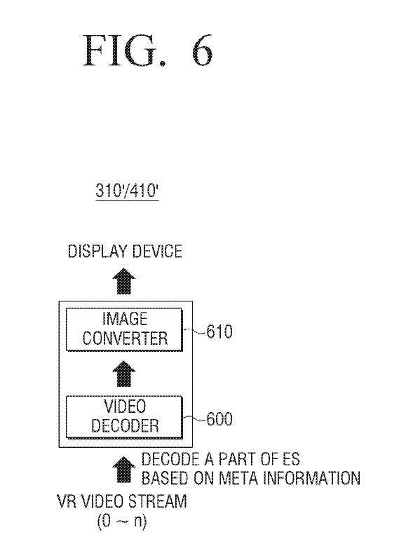

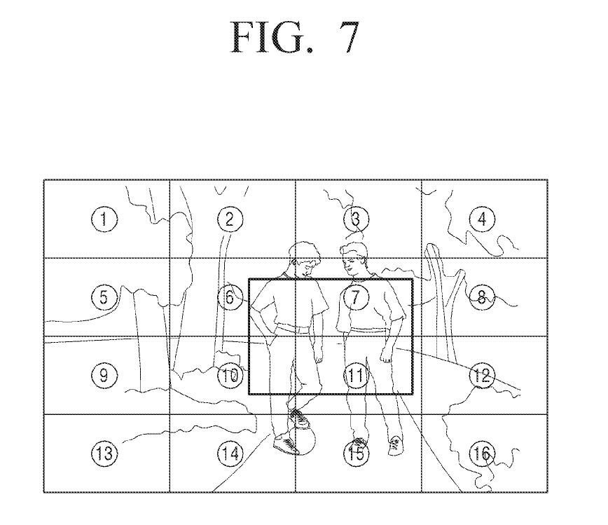

FIG. 6 is a diagram illustrating an example of a structure of the division-decoding signal processor of FIG. 3 or the division-decoding executor of FIG. 4, and FIG. 7 is a diagram illustrating an example VR planar image for describing selective decoding according to an example embodiment of the present disclosure.

The following embodiment will be described by taking an example of a division-decoding signal processor 310′ for convenience in explanation.

As illustrated in FIG. 6, the division-decoding signal processor 310′ according to another embodiment disclosed herein may include some or all of a video decoder 600 and an image converter 610.

The video decoder 600 selects only input picture data of a region that a user wants to watch among n number of piece of picture data and transmit the corresponding image to the image converter 610. In response to a new region being selected by the user from the VR image, dividing data in picture units may allow the decoding operation to be performed individually only with encoding data of the corresponding region. Further, the decoder supports data buffering to the GOP units for supporting the rapid scene change. That is, the decoder may store the data. Further, in response to a region being changed to another region, the decoder decodes the image from Picture-I of the corresponding region and provides a picture corresponding to a transition timing (or time section). Further, the decoder also provides encoding of low-resolution jpeg or only Picture-I (I only type) so as to be used until a GOP of a corresponding region appears in response to the region being changed rapidly by the user.

Referring to FIG. 7, in response to a VR image being divided into sixteen (16) regions for example, decoding may be performed with respect to the sixth, seventh, tenth, eleventh, fourteenth, and fifteenth images in order to provide an image in a yellow region as the user's region of interest. Accordingly, the video decoder 600 may decode only the pictures in the corresponding region and transmit the decoded image to the image converter 610. The image converter 610 may select and display only the image in the yellow region corresponding to the coordinate of the user's region of interest in the screen.

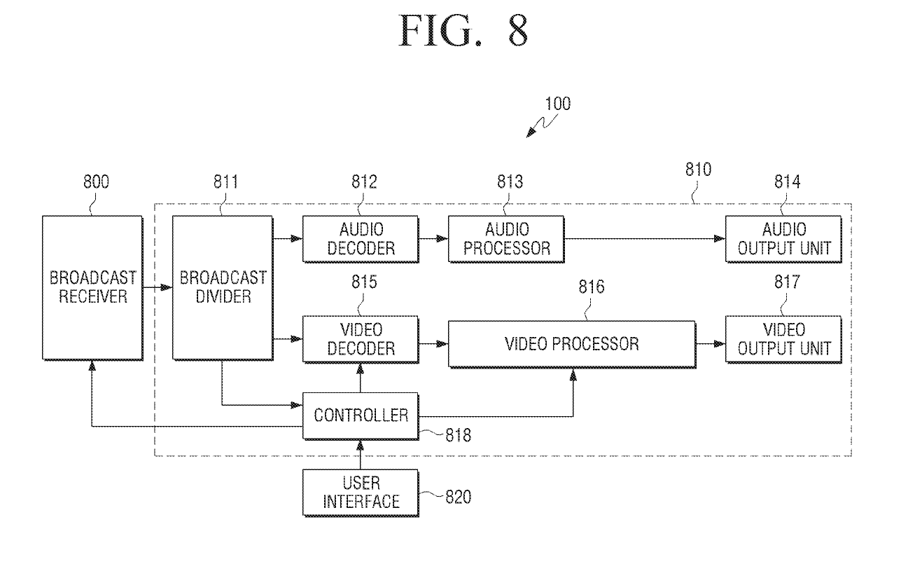

FIG. 8 is a block diagram illustrating an example of a structure of a first image display apparatus according to another example embodiment of the present disclosure.

The first image display apparatus 100 of FIG. 8 is illustrated by taking an example of a TV. The first image display apparatus 100 of FIG. 8 includes some or all of a broadcast receiver 800, a division-decoding signal processor 810, and a User Interface (UI) 820.

The broadcast receiver 800 may receive a broadcast signal and include a tuner and a demodulator. For example, when the user wants to watch a broadcast program of a certain channel, a controller 818 receives channel information on the channel through the UI 820 and tunes the tuner of the broadcast receiver 800 based on the received channel information. Consequently, the broadcast program of the channel selected by tuning is demodulated by the demodulator, and the demodulated broadcast data is inputted into a broadcast divider 811.

The broadcast divider 811 includes a demultiplexer and may divide the received the broadcast signal into video data, audio data, and additional information (for example, Electronic Program Guide (EPG) data). The divided additional information may be stored in a memory according to the control of the controller 818. In response to a user command to request for the additional information being received from the UI 820, the additional information, for example, the EPG, is combined with the scaled video data and outputted according to the control of the controller 818.

The controller 818 may select the pictures described with reference to FIG. 7 in the video decoder 815 based on the coordinate information on the user's region of interest inputted through the UI 820 and transmit the pictures to the video processor 816.

The video processor 816 may extract only the image data corresponding to the user's region of interest based on the coordinate information on the user's region of interest or scale the extracted data and output the data through the video output unit 817.

The audio decoder 812 decodes the audio, and the audio processor 813 post-processes the audio and the decoded and processed audio may be output through the audio output unit 814. The operations may be apparent to those skilled in the art, and thus, a repeated description is omitted.

Meanwhile, the selective decoding according to an embodiment disclosed herein is mainly performed by the video decoder 815, the video processor 816, and the controller 818 of FIG. 8.

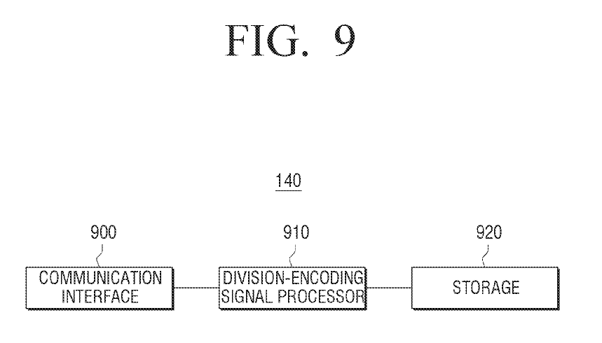

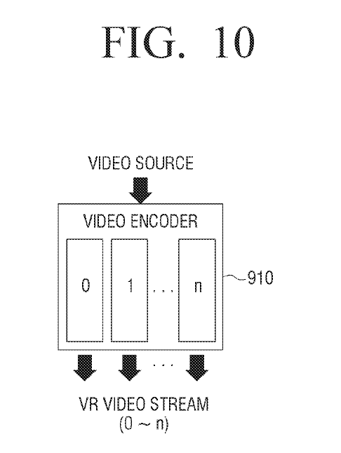

FIG. 9 is a block diagram illustrating an example of a structure of the service provider of FIG. 1, and FIG. 10 is a diagram illustrating an example division-encoding signal processor of FIG. 9.

As illustrated in FIG. 9, the service provider 140 includes some or all of a communication interface (e.g., including communication circuitry) 900, a division-encoding signal processor 910, and a storage 920. In this case, ‘including some or all of components’ may be interpreted the same as above.

The communication interface 900 communicates with the communication network 130 of FIG. 1. That is, in response to a VR image being requested by the user, the communication interface 900 provides the VR image stored in the storage 920. When the VR image is provided initially by a provider of the VR image, for example, by the division-encoding signal processor 910 or other component, an operation of dividing a region may have been processed such that the VR image includes the coordinate information on the divided region. In this case, the division of a region based on the user's region of interest refers to an operation of dividing images of the center parts and the upper and lower parts of a VR planar image in different sizes and storing the coordinate information on the images.

In response to receiving a user's request for the VR image, the division-encoding signal processor 910 may receive the VR image stored in the storage 920, that is, the VR image including the coordinate information, encode the VR image, and transmit the encoded VR image to the communication interface 900. In this case, the division-encoding signal processor 910 may encode the VR image on the basis of n number of pictures, as illustrated in FIG. 10.

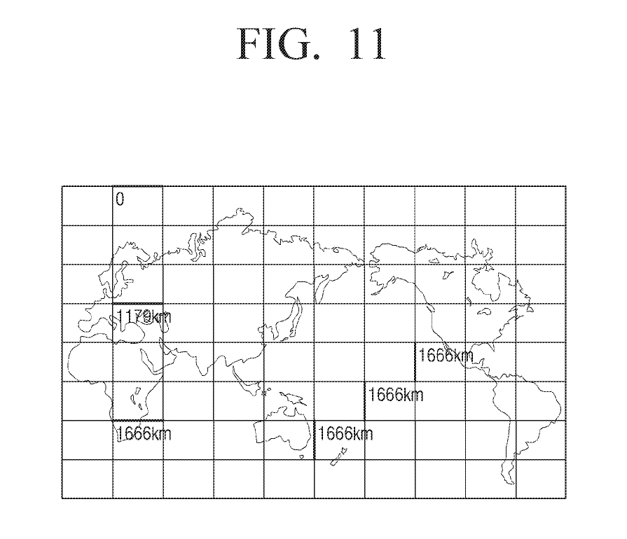

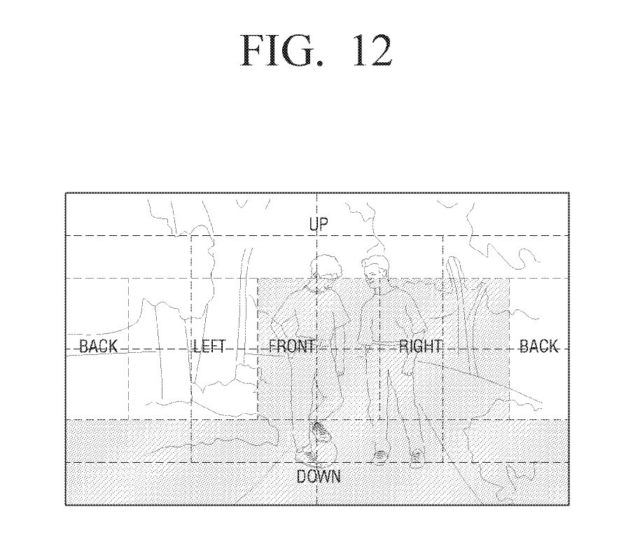

FIGS. 11 and 12 are diagrams illustrating examples of an unequally divided region for selective division-decoding according to an example embodiment of the present disclosure.

The 360-degree VR image may, for example, be an image realized by the equi-rectangular projection. Accordingly, referring to a planar image of FIG. 11, the regions in the vertical direction have the equal distance, and an information section per unit length of the regions in the horizontal direction becomes shorter toward ends of the upper part and lower part.

Accordingly, according to an embodiment disclosed herein, when the user wants to use the data at the ends of the upper and lower parts, a width of a necessary region is increased as compared with a screen of the center part, as illustrated in FIG. 12. Accordingly, more regions may be referred for the decoding.

In this regard, the embodiment may use a method of arranging a division unit to be equally spaced in the vertical direction and increasing the division unit towards the ends of the upper and lower parts for division-encoding of a screen.

This above-described method may lead to the maximum and/or improved efficiency of the division.

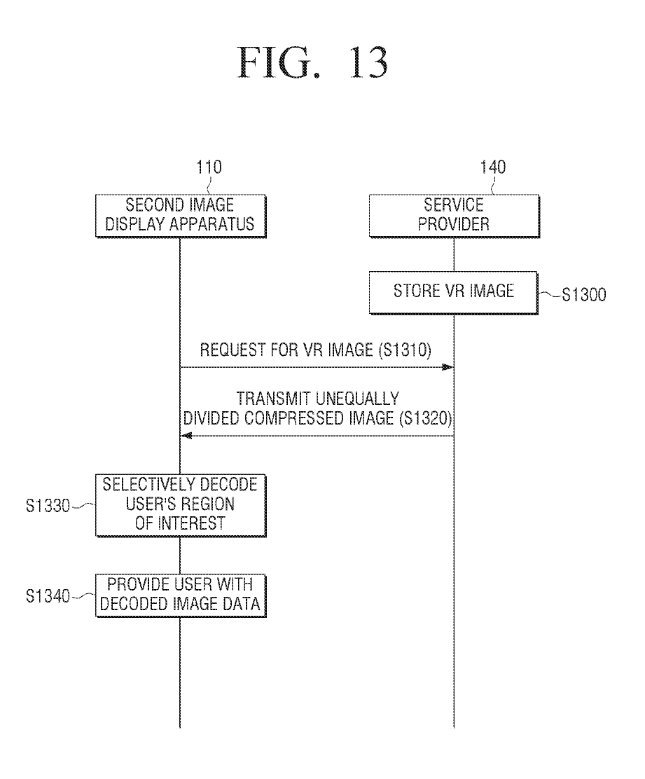

FIG. 13 is a sequence diagram illustrating an example service process according to an example embodiment of the present disclosure.

As illustrated in FIG. 13, the service provider 140 stores a VR image for the selective division-decoding according to an embodiment disclosed herein in order to provide a VR image service (S1300).

In response to receiving a request for the VR image from an image display apparatus (S1310), the service provider 140 transmits an unequally-divided compressed image to the second image display apparatus 110 (S1320).

The second image display apparatus 110 does not decode the received compressed image immediately and performs the selective decoding based on a user's of the second image display apparatus 110, that is, the user's region of interest (S1330). This operation was described above, and thus, a repeated description is omitted.

Subsequently, the second image display apparatus 110 provides the decoded image data to the user (S1340). In this case, the size of the image of the user's region of interest provided to the user may differ from the size of the decoded image. This operation was described above with reference to FIG. 7, and thus, a repeated description is omitted.

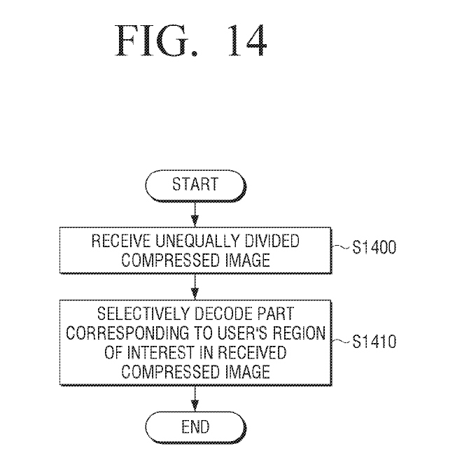

FIG. 14 is a flowchart illustrating an example of selective decoding process according to an example embodiment of the present disclosure. It may be seen that this process of FIG. 14 corresponds to a driving process of the first and second image display apparatuses 100, 110 of FIG. 1 or the image relay apparatus 120.

Referring to the second image display apparatus 110 of FIG. 1 for convenience in explanation, the second image display apparatus 110 receives an unequally divided compressed image from the service provider 140 (S1400).

Subsequently, the second image display apparatus 110 selects and decodes a region consistent with (or corresponding to) the user's region of interest from the received compressed image (S1410).

The second image display apparatus 110 may extract only the image data corresponding to the user's region of interest from the decoded image data and display the extracted image data in the screen.

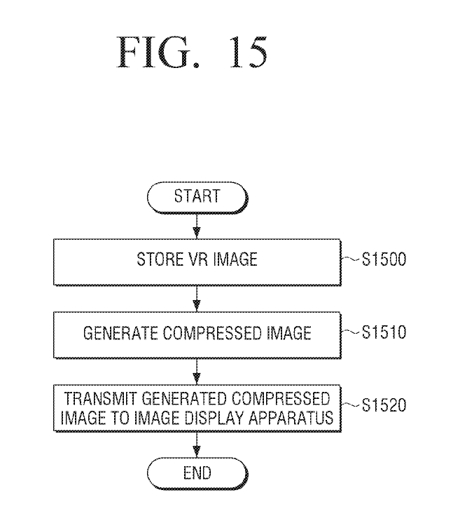

FIG. 15 is a flowchart illustrating an example process of generating an unequally divided compressed image according to an example embodiment of the present disclosure. It may be seen that this process of FIG. 15 corresponds to a driving process of the service provider 140 of FIG. 1.

Referring to FIG. 1 for convenience in explanation, the service provider 140 receives and stores a VR image from an image manufacturer (S1500). In this case, the service provider 140 may divide a region of the stored VR image unequally according to an embodiment disclosed herein and store the unequally divided compressed image along with the coordinate information. In this case, the VR image is a VR planar image.

In response to receiving a user's request, the service provider 140 generates a compressed image according to an embodiment disclosed herein (S1510). For example, the service provider 140 may generate a compressed image including the coordinate information.

Subsequently, the service provider 140 may transmit the generated compressed image a compressed image according to an embodiment disclosed herein to the second image display apparatus 110, for example (S1520).

So far, it has been described that entire components in the above embodiments of the present disclosure are combined as one component or operate in combination with each other, but the embodiments disclosed herein are not limited thereto. That is, unless it goes beyond a range of purpose of the present disclosure, the entire components may be selectively combined and operate as one or more components. Further, each of the entire components may be realized as independent hardware, or some or all of the components may be selectively combined and realized as a computer program having a program module which performs a part or all of the functions combined in one piece or a plurality of pieces of hardware. Codes and code segments comprising the computer program may be easily derived by those skilled in the art. The computer program may be stored in a non-transitory computer readable medium to be read and executed by a computer thereby realizing the embodiments of the present disclosure.

The non-transitory computer readable recording medium refers to a machine-readable medium that stores data. For example, the above-described various applications and programs may be stored in and provided through the non-transitory computer-readable recording medium, such as, a Compact Disc (CD), a Digital Versatile Disk (DVD), a hard disk, a Blu-ray disk, a Universal Serial Bus (USB), a memory card, a Read-Only Memory (ROM), or the like.

As above, various example embodiments have been illustrated and described. The foregoing example embodiments and advantages are merely examples and are not to be construed as limiting the present disclosure. The present teaching can be readily applied to other types of devices. Also, the description of the example embodiments is intended to be illustrative, and not to limit the scope of the claims, and many alternatives, modifications, and variations will be apparent to those skilled in the art.

What is claimed is:

1. An image display apparatus comprising:
an image receiver configured to receive a plurality of compressed images comprising an original image;
a signal processor configured to decode a compressed image corresponding to a region of interest from among the plurality of received compressed images; and
a display configured to display the decoded compressed image.

2. The apparatus as claimed in claim 1, wherein the image receiver is configured to receive coordinate information on a region divided on a hourly basis in the plurality of compressed images together with the plurality of compressed images,
wherein the signal processor is configured to decode the compressed image corresponding to the region of interest based on the received coordinate information.

3. The apparatus as claimed in claim 1, wherein the image receiver is configured to receive the plurality of compressed images with a different size of region divided on a hourly basis.

4. The apparatus as claimed in claim 1, wherein the image receiver is configured to receive a planar image expressed as an equi-rectangular projection to display a Virtual Reality (VR) image in a screen as the original image.

5. The apparatus as claimed in claim 1, further comprising:
a storage configured to store the plurality of received compressed images in Group of Pictures (GOP) units,
wherein the signal processor is configured to decode the compressed image corresponding to the region of interest in the compressed images stored in the GOP units.

6. The apparatus as claimed in claim 1, wherein the signal processor is configured to decode the compressed image from at least one of a previous frame and a subsequent frame of a current frame corresponding to the region of interest.

7. The apparatus as claimed in claim 1, wherein in response to the plurality of received compressed images being low-resolution images, the signal processor is configured to decode the compressed image to an ending point of the GOP units of the compressed image corresponding to the region of interest.

8. The apparatus as claimed in claim 7, wherein the low-resolution images comprise a thumbnail image.

9. A method for driving an image display apparatus, the method comprising:
receiving a plurality of compressed images comprising an original image;
decoding a compressed image corresponding to a region of interest from among the plurality of received compressed images; and
displaying the decoded compressed image.

10. The method as claimed in claim 9, wherein the receiving comprises receiving coordinate information on a region divided on a hourly basis in the plurality of compressed images together with the plurality of compressed images,
wherein the decoding comprises decoding the compressed image corresponding to the region of interest based on the received coordinate information.

11. The method as claimed in claim 9, wherein the receiving comprises receiving the plurality of compressed images with a different size of region divided on a hourly basis.

12. The method as claimed in claim 9, wherein the receiving comprises receiving a planar image expressed as an equi-rectangular projection to display a Virtual Reality (VR) image in a screen as the original image.

13. The method as claimed in claim 9, further comprising:
storing the plurality of received compressed images in Group Of Pictures (GOP) units,
wherein the decoding comprises decoding the compressed image corresponding to the region of interest in the compressed images stored in the GOP units.

14. The method as claimed in claim 9, wherein the decoding comprises decoding the compressed image from at least one of a previous frame and a subsequent frame of a current frame corresponding to the region of interest.

15. The method as claimed in claim 9, wherein in response to the plurality of received compressed images being low-resolution images, the decoding comprises decoding the compressed image to an ending point of the GOP units of the compressed image corresponding to the region of interest.

16. The method as claimed in claim 15, wherein the low-resolution images comprise a thumbnail image.

17. A non-transitory computer-readable recording medium with a program for executing a method for driving an image display apparatus, the method comprising:
receiving a plurality of compressed images comprising an original image; and
decoding a compressed image corresponding to a region of interest from among the plurality of received compressed images.
